(19) United States
(12) Patent Application Publication
(10) Pub. No.: US 2010/0297310 A1
(43) Pub. Date: Nov. 25, 2010

(54) TRAY INCLUDING A FLOW RESTRICTING ELEMENT FOR FOOD PRODUCTS

(76) Inventors: JOANNE J. GARBE, Columbia Heights, MN (US); LINDA OLSON, Golden Valley, MN (US); SCOTT KACKMAN, New Hope, MN (US); CHERYL A. STEPHENS, Forest Lake, MN (US); STEVEN L. REIL, Blaine, MN (US)

Correspondence Address: GENERAL MILLS, INC., P.O. BOX 1113, MINNEAPOLIS, MN, 55440, US

(21) Appl. No.: 12/468,882

(22) Filed: May 20, 2009

(51) Int. Cl. A21D 10/02; B65D 1/34

(52) U.S. Cl. 426/113; 426/128; 206/564

(57) ABSTRACT

A tray configured to contain a food product is described. The bottom surface of the tray includes a flow restricting element which restricts the flow of the food product in the tray. The flow restricting element may include one or more elongated ridges that protrude from the bottom surface of the tray. The flow restricting element may also include a raised pattern on the bottom surface of the tray. By restricting the flow of the food product in the tray, the flow restricting element may reduce or eliminate slippage or slumping of the food product when the tray is placed in a non-horizontal position. Also described is a packaged food product including a tray which contains a dough. The packaged food product is capable of being displayed in a non-horizontal configuration with little or no slumping of the food product.

### TECHNICAL FIELD

The invention relates to a tray or pan for food products, wherein the tray is configured to reduce or eliminate slumping of a food product contained in the tray when the tray is stored in a non-horizontal position.

### BACKGROUND

Due to time constraints placed on the average consumer and the convenience of ready-to-bake products, the popularity of items than can go directly from the refrigerator to the oven has increased dramatically. One ready-to-bake food category that continues to grow in popularity is refrigerated dough products that are purchased in a pre-formed configuration such that upon removal of the packaging, they are immediately ready for baking. At time of use, these ready-to-bake refrigerated dough products can be placed directly into an oven and baked so as to result in freshly baked dough products in a matter of minutes.

Within the ready-to-bake refrigerated dough product category, refrigerated dessert products are especially popular as they generally take only minutes to prepare and can quickly provide the desirable organoleptic characteristics associated with homemade desserts or snacks. Examples of common refrigerated dessert and snack products include cookies, brownies and bars.

While refrigerated ready-to-bake dessert and snack products provide great convenience for the consumer, the flow properties of the unbaked dough can create difficulties in maintaining expected appearance and performance during refrigerated distribution and storage. These difficulties can be further increased due to the manner in which these products are displayed and presented to consumers for purchase at a grocery store. For instance, ready-to-bake dough packaging frequently includes a “window” of transparent packaging such that when the ready-to-bake dough is displayed standing up, the consumer can see a top surface of the ready-to-bake dough, including any toppings. Unfortunately, this type of storage can lead to upper portions of the refrigerated dough sagging, slipping, or “slumping” from an upper edge of the packaging or pan. This dough slumping can result in uneven baking and inconsistent or even unusable baked product and can appear unappealing to a consumer if dough slumping is observed prior to purchase.

Crystalline polyethylene terephthalate (CPET) is frequently used as a tray for refrigerated ready-to-bake dough products, because CPET can withstand a wide range of temperatures, including both refrigeration temperatures and baking temperatures. Therefore, the refrigerated, ready-to-bake dough product can be baked in the same tray in which it is packaged, distributed, stored and sold. CPET has a low coefficient of friction, which may be advantageous to keep the baked finished product from sticking to the tray. However, this low coefficient of friction may exacerbate the problem of slippage or slumping of the ready-to-bake product contained in the tray.

### SUMMARY

It has been discovered that by adding a flow restricting element to the bottom surface of a tray or pan for food products, slippage or slumping of the food product contained in the tray may be reduced or eliminated, even when the tray or pan is stored in a non-horizontal position. As used herein, “slump” refers to the movement of a dough, generally along the vertical axis, such that the dough's original shape or dimension is compromised. As used herein, a “non-horizontal position” or “non-horizontal configuration” is a position in which the tray is placed at any angle greater than 0 degrees, where 0 degrees refers to the tray being laid flat on its bottom surface.

The present invention is directed to a tray configured to contain a food product. The bottom surface of the tray includes a flow restricting element which restricts the flow of the food product in the tray. The flow restricting element may include one or more elongated ridges, wherein each ridge protrudes from the bottom surface of the tray into a food containing area of the tray. The flow restricting element may also include a raised pattern on the bottom surface of the tray. By restricting the flow of the food product in the tray, the flow restricting element may reduce or eliminate slippage or slumping of the food product.

The present invention is also directed to a packaged food product including a tray which contains a dough. The packaged food product is capable of being displayed in a non-horizontal configuration substantially without slippage or slumping of the food product.

The foregoing has outlined rather broadly the features and technical advantages of the present invention in order that the detailed description of the invention that follows may be better understood. Additional features of the invention which form the subject of the claims of the invention will be described hereinafter. It should be appreciated by those skilled in the art that the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

FIG. 1a is a top view of an embodiment of a tray made in accordance with the present invention. FIG. 1b is a perspective view of the tray shown in FIG. 1a.

FIG. 2a is a top plan view of the tray shown in FIG. 1a. FIG. 2b is a cross-sectional view of the tray of FIG. 2a, taken along line A-A′.

FIG. 3a is a top view of an embodiment of a tray made in accordance with the present invention. FIG. 3b is a perspective view of the tray shown in FIG. 3a.

FIG. 4a is a top view of an embodiment of a tray made in accordance with the present invention. FIG. 4b is a perspective view of the tray shown in FIG. 4a.

FIG. 5a is a top plan view of the tray shown in FIG. 4a. FIG. 5b is a cross-sectional view of the tray of FIG. 5a, taken along line A-A′.

### DESCRIPTION

The present invention is directed to a tray or pan for food products, wherein the tray is configured to contain the food product and to reduce or eliminate slippage or slumping of the product when contained in the tray. Specifically, the tray is configured to reduce or eliminate slumping of the food product when the tray containing the product is stored in a non-horizontal position. A non-horizontal position can be at any angle greater than 0 degrees, where 0 degrees refers to the tray being laid flat on its bottom surface. Examples of non-horizontal positions include 30 degrees, 45 degrees, 60 degrees and 90 degrees, and various other degrees between 0 and 90, which can be found, for example, when the product is on display on the grocery store shelves. During distribution and handling, the tray containing the product may be positioned in other non-horizontal positions having varying degrees, ranging from 0 degrees to 360 degrees.

As described in co-pending U.S. patent application Ser. No. 12/277,608, the teachings of which are incorporated by reference in their entirety herein, these non-horizontal positions are typically detrimental to the food product contained within the tray. To alleviate these detrimental effects of non-horizontal positions, it was found that configuring the tray to include a flow restricting element to hinder or prevent the flow of the product (also known as slippage or slumping) substantially reduced or eliminated the slumping of the food product. The flow restricting element serves several functions, and while not intending to be bound by theory, it is believed that the combination of functions results in the reduction or elimination of product slumping.

Product slumping occurs when the food product is positioned such that the angle of the product, combined with its weight, exerts sufficient force on the food product to cause it to flow, typically to one edge or side of a package or container.

One function of the flow restricting element is to increase the surface area of the pan area. The increased surface area functions to provide greater contact between the bottom surface of the tray and the food product, thereby increasing the amount of adhesive (cohesive) force between the food product and the pan or tray. In order for the product to slip or slump, therefore, this increased adhesive/cohesive force would need to be overcome, rendering it more difficult to slip or slump during conventional handling or storage.

Another function of the flow restricting element is to act as a physical barrier to block the flow of the product. By placing the flow restricting element at desired angles and intervals along the bottom surface of the tray or pan, it was found that even under conditions favorable for the product to flow, the barrier effect of the flow restricting element reduced or prevented product flow from occurring in the vicinity of the flow restricting element. A plurality of flow restricting elements creates a series of localized barriers, which function together to keep the entire quantity of the product from slipping or slumping.

It was also discovered that the angle of the flow restricting element relative to the bottom surface of the tray had an impact on the restricting element's ability to serve as a flow barrier. For example, if the flow restricting element has a wall that is approximately perpendicular to the bottom surface, little or no flow occurs over or across that element. Flow restricting elements at angles that are less than or greater than 90 degrees in relation to the bottom surface provide some degree of barrier functionality, but it was found that the product flows more readily over these flow restricting elements than those having a wall that is approximately perpendicular to the bottom surface of the tray or pan. As used herein, the expression “approximately perpendicular” shall refer to a ridge wall angle that is between about 75 degrees and 105 degrees relative to the bottom surface.

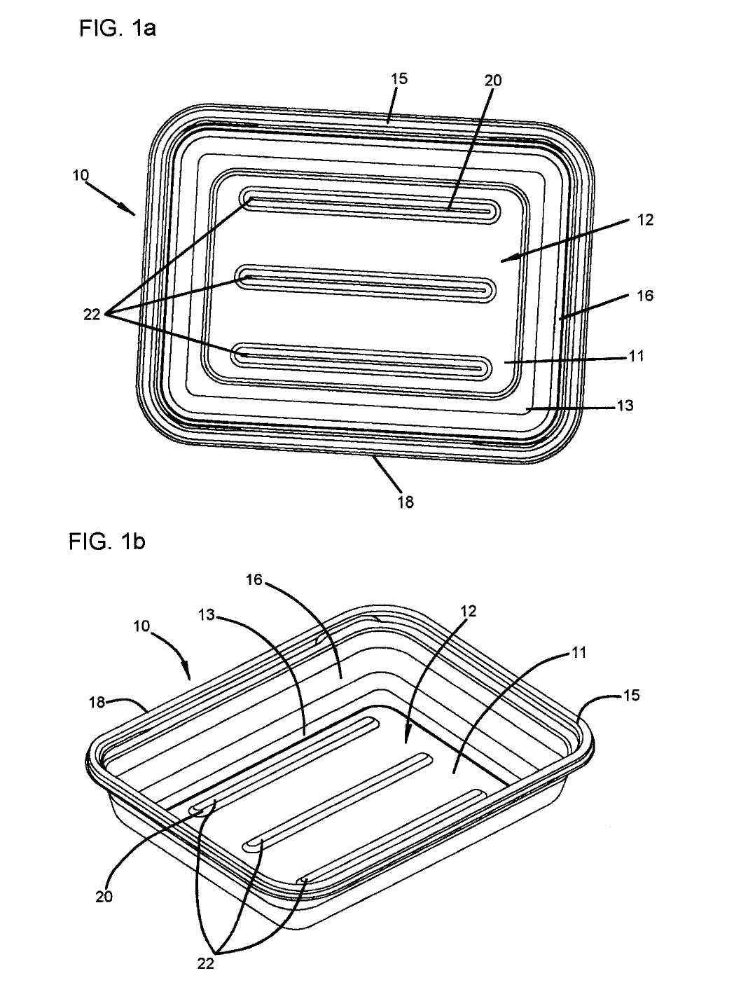

FIGS. 1a-b show one example of a tray in accordance with the present invention. FIG. 1a is a top view of the tray, while FIG. 1b is a perspective view of the tray. Tray 10 comprises bottom surface 12 and side wall 16. In this embodiment, bottom surface 12 is generally rectangular, with curved corners. The central portion 11 of the bottom surface 12 is raised above the edge portion 13 of the bottom surface. A ridge 15 runs around the edge of the tray 10. Flow restricting element 20, in this embodiment, is an elongated protruding ridge 22 that runs approximately parallel to the portions of side wall 16 along the long sides 18 of the tray. FIGS. 1a-b depict a plurality of ridges 22 to restrict the flow of a product placed within tray 10.

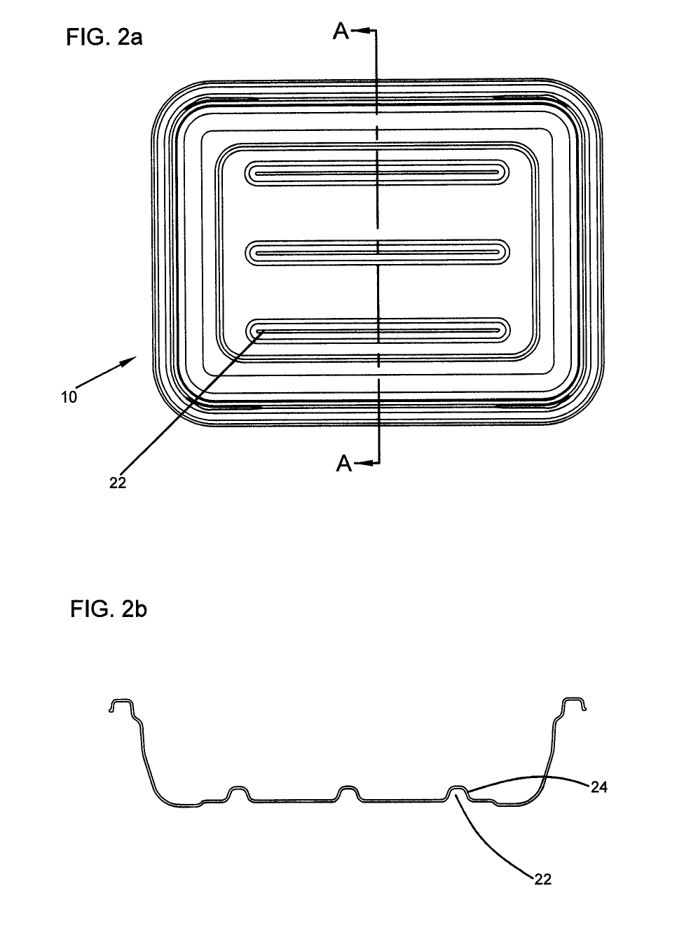

Ridge 22 may have any cross-sectional profile desired, although as described above, providing ridge 22 with at least one ridge wall 24 that is positioned approximately perpendicular to bottom surface 12 may improve the barrier function of ridge 22. Ridge wall 24 is shown in FIG. 2b, which is a cross-sectional view of the tray, taken along line A-A′ of FIG. 2a. FIG. 2a is a top plan view of the tray of FIGS. 1a-b.

The surface area of the flow restricting elements 20 of tray 10 of FIGS. 1a-b comprises about 15% of the total surface area of the bottom surface of the tray. For trays of the present invention, examples of the percentage of the total surface area of the bottom surface of the tray that is comprised of the surface area of flow restricting elements can range from about 10% to about 50%. As used herein, the expression “total surface area” shall refer to the surface area of the bottom of the tray onto which a food product may be positioned.

As compared to a similar tray without flow restricting elements 20, tray 10 of FIGS. 1a-b represents about a 5.8% increase in the total surface area of the bottom surface of the tray. Any increase in surface area compared to a similar tray or pan without flow restricting elements will serve to increase the cohesive force between a product and the tray, thereby aiding in keeping the product in place in the tray or pan. Examples of increases in surface area of the bottom surface of the tray or pan of the present invention can include increases ranging from about 5% to about 30% of the surface area of the bottom surface of a comparable tray or pan without a flow restricting element.

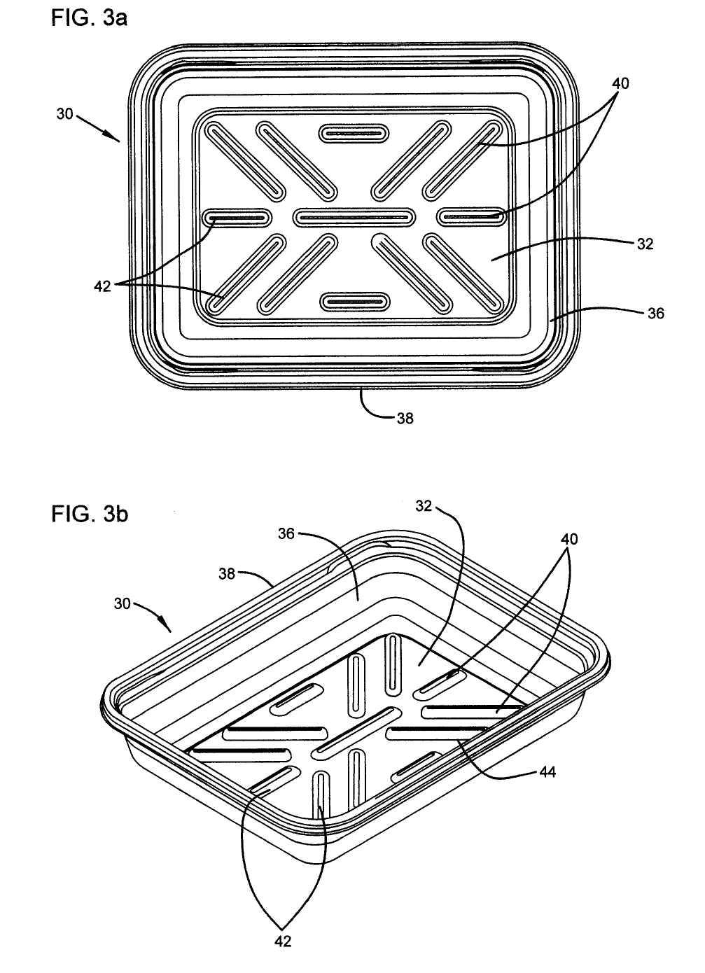

The position of the flow restricting element relative to the side or sides of the pan or tray also has an impact on the ability of the restricting element to serve as a flow barrier. FIG. 3a shows a top view, and FIG. 3b shows a perspective view, of a tray 30 in accordance with the present invention in which some of the flow restricting elements 40 are positioned on the bottom surface 32 at an angle or diagonally relative to a side wall 36 of the tray, while other flow restricting elements 40 are positioned parallel relative to a side wall 36 of the tray. Specifically, some flow restricting elements 40 are positioned at an angle of about 45 degrees or about 135 degrees relative to a long side 38 of the tray, while some of the flow restricting elements 40 are parallel to a long side 38 of the tray.

The flow restricting elements 40 shown in FIGS. 3a-b provide an increased surface area of bottom surface 32 compared to a tray or pan without flow restricting elements. The flow restricting elements 40 also provide the barrier effects of each elongated protruding ridge 42 having a ridge wall 44 that is approximately perpendicular to bottom surface 32.

The surface area of the flow restricting elements 40 of tray 30 of FIGS. 3a-b comprises about 22% of the total surface area of the bottom surface of the tray. As compared to a similar tray without flow restricting elements 40, tray 30 represents about a 9% increase in the total surface area of the bottom surface of the tray.

Flow restricting elements may be positioned at any angle of between about 0 degrees and about 180 degrees relative to one side of the bottom surface of the tray. In some embodiments, flow restricting elements may be positioned at any angle of between about 30 degrees and about 150 degrees.

Because some of the flow restricting elements 40 in FIGS. 3a-b are positioned diagonally, it was unexpectedly discovered that having such diagonal elements improves the flow restricting abilities of the tray or pan of the present invention. This is unexpected due to the fact that diagonally positioned elements inherently have a downward slope if the tray is placed on one end, and would therefore not be expected to have greater flow restrictive properties compared to a tray with horizontally positioned flow restricting elements as in FIG. 1.

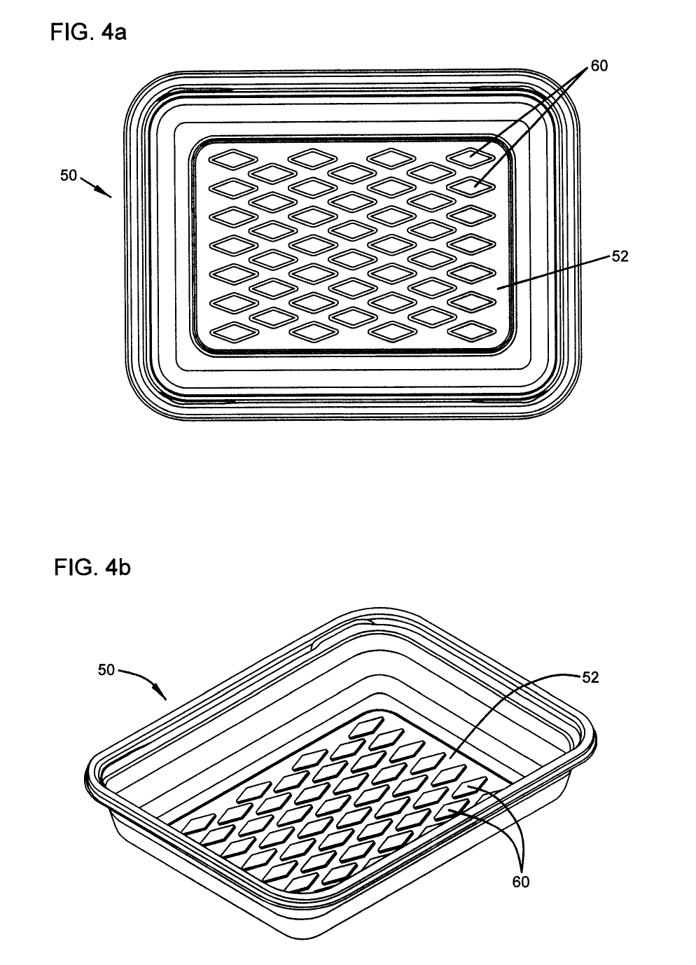

FIGS. 4a-b show another example of the tray or pan of the present invention. FIG. 4a is a top view of tray 50, while FIG. 4b is a perspective view of the tray. Tray 50 includes a bottom surface 52 having a plurality of raised elements 60. The raised elements 60 are flow restricting elements. Raised elements 60, in the embodiment shown in FIGS. 4a-b, are diamond-shaped, but can be of any shape desired. For example, the raised elements may be angular elements. Raised elements 60 can be positioned anywhere on bottom surface 52, but are most conveniently placed in a pattern across bottom surface 52. The pattern of raised elements, or, the raised pattern, may include a combination of different raised elements. Raised elements 60, similar to the elongated ridges described above, have an element wall 64 that is approximately perpendicular to bottom surface 52.

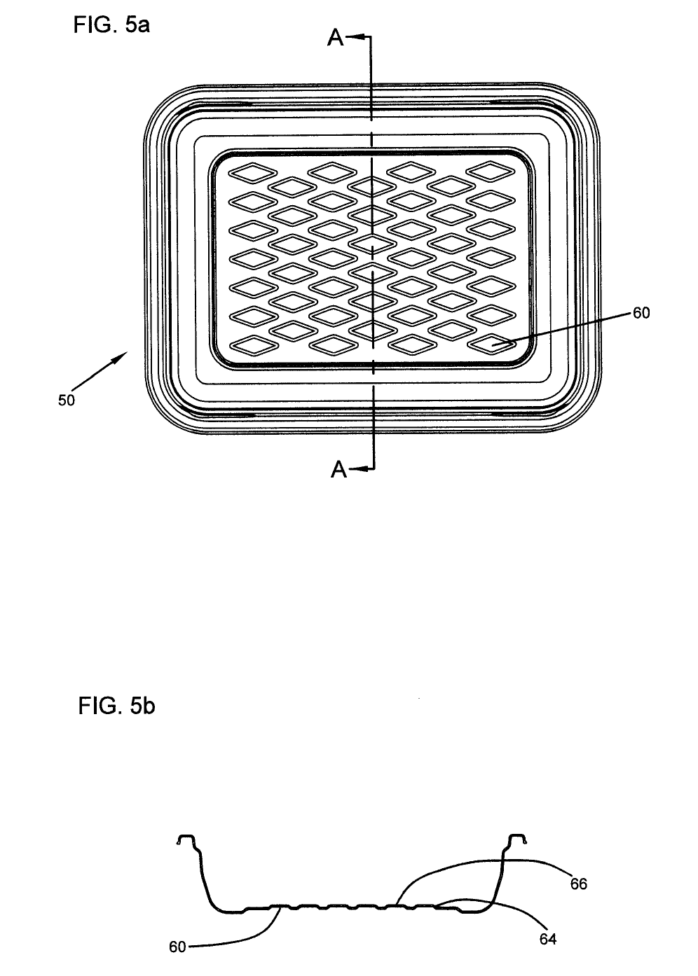

FIG. 5a is a top plan view of the tray of FIGS. 4a-b, while FIG. 5b is a cross-sectional view of the tray, taken along line A-A′ of FIG. 5a. As shown in FIG. 5b, the raised elements 60 preferably each have a flat top section 66 that serves to increase the surface area of this type of flow restricting element, thereby increasing the cohesive force between a product and the tray or pan.

The surface area of the raised elements 60 of tray 50 of FIGS. 4a-b comprises about 34% of the total surface area of the bottom surface of the tray. As compared to a similar tray without raised elements 60, tray 50 represents about a 16% increase in the total surface area of the bottom surface of the tray.

The trays shown in FIGS. 1-5 each have a bottom surface and corresponding shape that are generally rectangular. However, the tray in accordance with the present invention may have any shape. For example, the tray may be generally circular in shape such as for a ready-to-bake pizza or pie crust dough, or it may have an irregular shape, such as a novelty shape, suitable for a shaped ready-to-bake dough. Examples of shapes include heart, oval, floral, elliptical, and the like.

The flow restricting elements of the trays of FIGS. 1-3 are elongated ridges on the bottom surfaces of the trays, while the flow restricting elements of the trays of FIGS. 4-5 are raised patterns on the bottom surfaces of the trays. However, the flow restricting elements of the trays of the present invention may have various configurations. For example, a flow restricting element may include an arcuate ridge or ridges, a wavy or “zig-zag” ridge or ridges, or a radial ridge or ridges on a bottom surface of a tray.

In some embodiments, the tray of the present invention is made of a material that can withstand baking temperatures. Trays of the present invention may also be made of materials that are capable of transitioning from typical frozen temperatures to typical refrigerated temperatures and to typical baking temperatures. For example, a tray of the present invention may be fabricated of disposable or reusable materials such as aluminum foil, paperboard and oven bakeable plastic, such as CPET.

A packaged food product may also be made in accordance with the present invention. The packaged food product includes both a tray of the present invention and a food product contained within the tray. The food product contained in the tray may be a dough. An example of a dough that may be used is a refrigerated ready-to-bake product, such as a refrigerated dessert dough product. Examples of doughs that may be used in accordance with the present invention also include slump-resistant refrigerated dough products. A slump-resistant refrigerated dough product is a refrigerated dough product that has been formulated to reduce or eliminate the slumping or slippage of the refrigerated dough product in a tray, such as the dough described in co-pending U.S. patent application Ser. No. 12/277,608, which is hereby incorporated by reference in its entirety.

In one embodiment of a packaged food product, a transparent or semi-transparent film can be fixedly attached to the tray at the edge of the tray, or at the ridge around the edge of the tray. The film can serve a variety of purposes including maintaining food product freshness, protection, retaining food product within the tray, and/or providing a consumer a view of the food product. The film may also provide a medium for displaying text such as ingredients, storage instructions, and baking and handling instructions. The film may also display trademarks and/or other symbols.

The packaged food product may also include additional external packaging such as a box or other protective packaging such as a sleeve. A window in the box or sleeve, for viewing the food product in the tray, may also be included for aesthetic appeal, or to provide a means for viewing any text, trademarks, or symbols printed on the film attached to the tray. The box or sleeve may also provide a medium for displaying text such as ingredients, storage instructions, and baking and handling instructions. The box or sleeve may also display trademarks and/or other symbols.

### EXAMPLE 1

### Slump Distance Measurements at Different Temperatures

The ability of different trays to reduce or eliminate the slumping of a food product contained in the trays was evaluated. A conventional dessert bar dough containing 12% peanut butter by weight was placed in three different types of trays: a control tray without flow restricting elements; the tray shown in FIG. 3, which included both diagonal and horizontal elongated ridges on the bottom surface; and the tray shown in FIG. 4, which included a pattern of diamond-shaped raised elements on the bottom surface. The dough was placed in the trays such that each tray contained a thin sheet of dough approximately 0.5 inches thick. A transparent film was attached to each tray at the ridge around the edge of the tray. One set of trays was placed in a 40° F. chamber, a second set of trays was placed in a 50° F. chamber, and a third set of trays was placed in a 60° F. chamber. Each tray was placed on a shelf in a landscape, vertical position, such that the angle between the bottom of the tray and the shelf was approximately 90 degrees.

The slump distance of the dough in each tray was measured, where the slump distance is the distance between the initial dough height and the dough height after a period of 87 days. The results of these measurements are recorded in Table 1.

TABLE 1
Slump Distance After 87 Days

| Temperature of | Control Tray: | FIG. 3 Tray: | FIG. 4 Tray: |
|---|---|---|---|
| Chamber Containing | Slump Distance | Slump Distance | Slump Distance |
| Tray | (in inches) | (in inches) | (in inches) |
| 40° F. | 0.15 | 0.05 | 0.03 |
| 50° F. | 0.65 | 0.00 | 0.00 |
| 60° F. | 1.28 | 0.10 | 0.53 |

Both the tray shown in FIG. 3 and the tray shown in FIG. 4 were effective in reducing product slump, in comparison to the control tray. However, when maintained at a temperature of 60° F., the tray of FIG. 3 was more effective in reducing product slump than the tray of FIG. 4. Therefore, the tray which included both diagonal and horizontal elongated ridges on the bottom surface was more effective in reducing product slump than the tray which included a pattern of diamond-shaped raised elements.

### EXAMPLE 2

### Slump Distance Measurements Over Time

The ability of different trays to reduce or eliminate the slumping of a food product contained in the trays was evaluated. A slump-resistant dessert bar dough containing 4% peanut butter by weight was placed in four different types of trays: a control tray without flow restricting elements; the tray shown in FIG. 1, which included three horizontal elongated ridges on the bottom surface; the tray shown in FIG. 3, which included both diagonal and horizontal elongated ridges on the bottom surface; and the tray shown in FIG. 4, which included a pattern of diamond-shaped raised elements on the bottom surface.

The dough was placed in five trays of each type, such that each tray contained a thin sheet of dough approximately 0.5 inches thick. A transparent film was attached to each tray at the ridge around the edge of the tray. The trays were placed in a 85° F. chamber. Each tray was placed on a shelf in a landscape, vertical position, such that the angle between the bottom of the tray and the shelf was approximately 90 degrees.

The slump distance of the dough in each tray was measured, where the slump distance is the distance between the initial dough height and the dough height after a period of time. The slump distance measurements were taken after 30, 60, 90, and 120 minutes. The average slump distance for each of the four types of trays was calculated. The results of these calculations are recorded in Table 2.

TABLE 2
Slump Distance of Slump-Resistant Dessert Bar Dough
Containing 4% Peanut Butter

| | Control | | | |
|---|---|---|---|---|
| Time at which | Tray: | FIG. 1 Tray: | FIG. 3 Tray: | FIG. 4 Tray: |
| Slump Distance | Average | Average | Average | Average |
| Measurements | Slump | Slump | Slump | Slump |
| Were Taken | Distance | Distance | Distance | Distance |
| (in minutes) | (in inches) | (in inches) | (in inches) | (in inches) |
| 30 | 0.7 | 0.15 | 0.0 | 0.0 |
| 60 | 1.3125 | 0.2 | 0.0 | 0.0 |
| 90 | 1.75 | 0.2 | 0.0 | 0.05 |
| 120 | 3.5 | 0.2 | 0.0 | 0.05 |

The trays shown in FIGS. 1, 3, and 4 were all effective in reducing product slump, in comparison to the control tray. The trays shown in FIGS. 3 and 4 were more effective in reducing product slump than the tray of FIG. 1, which included three elongated horizontal ridges on the bottom surface. After 90 and 120 minutes, the tray shown FIG. 3 was more effective in reducing product slump than the tray shown in FIG. 4. Therefore, the tray which included both diagonal and horizontal elongated ridges on the bottom surface was more effective in reducing product slump than both the tray which included a pattern of diamond-shaped raised elements on the bottom surface, and the tray which included three elongated horizontal ridges on the bottom surface. This is unexpected due to the fact that diagonally positioned elements, such as those in FIG. 3, inherently have a downward slope if the tray is placed on one end, and would therefore not be expected to have greater flow restrictive properties compared to a tray with horizontally positioned flow restricting elements as in FIG. 1.

A conventional dessert bar dough containing 12% peanut butter by weight was also placed in the four different types of trays used in the above experiment: a control tray without flow restricting elements; the tray shown in FIG. 1, which included three horizontal elongated ridges on the bottom surface; the tray shown in FIG. 3, which included both diagonal and horizontal elongated ridges on the bottom surface; and the tray shown in FIG. 4, which included a pattern of diamond-shaped raised elements on the bottom surface.

The dough was placed in five trays of each type, such that each tray contained a thin sheet of dough approximately 0.5 inches thick. A transparent film was attached to each tray at the ridge around the edge of the tray. The trays were placed in a 85° F. chamber. Each tray was placed on a shelf in a landscape, vertical position, such that the angle between the bottom of the tray and the shelf was approximately 90 degrees.

The slump distance of the dough in each tray was measured, where the slump distance is the distance between the initial dough height and the dough height after a period of time. The slump distance measurements were taken after 30, 60, 90, and 120 minutes. The average slump distance for each of the four types of trays was calculated. The results of these calculations are recorded in Table 3. An average slump distance of 4 inches indicated complete slump of the product to the side of the tray proximate to the shelf upon which the tray was placed.

TABLE 3
Slump Distance of Conventional Dessert Bar Dough
Containing 12% Peanut Butter

| | Control | | | |
|---|---|---|---|---|
| Time at which | Tray: | FIG. 1 Tray: | FIG. 3 Tray: | FIG. 4 Tray: |
| Slump Distance | Average | Average | Average | Average |
| Measurements | Slump | Slump | Slump | Slump |
| Were Taken | Distance | Distance | Distance | Distance |
| (in minutes) | (in inches) | (in inches) | (in inches) | (in inches) |
| 30 | 4 | 1.1 | 0.0 | 0.0 |
| 60 | 4 | 2.5 | 0.0 | 0.0 |
| 90 | 4 | 3.2 | 0.0 | 0.0 |
| 120 | 4 | 3.2 | 0.0 | 0.0 |

The trays shown in FIGS. 1, 3, and 4 were all effective in reducing product slump, in comparison to the control tray. The trays shown in FIGS. 3 and 4 were more effective in reducing product slump than the tray of FIG. 1. Therefore, both the tray which included diagonal and horizontal elongated ridges on the bottom surface, and the tray which included a pattern of diamond-shaped raised elements on the bottom surface, were more effective in reducing product slump than the tray which included three elongated horizontal ridges on the bottom surface. As stated above, this result is unexpected due to the fact that diagonally positioned elements, such as those in FIG. 3, inherently have a downward slope if the tray is placed on one end, and would therefore not be expected to have greater flow restrictive properties compared to a tray with horizontally positioned flow restricting elements as in FIG. 1.

Although the present invention and it advantages have been described in detail, it should be understood that various changes, substitutions and alterations can be made herein without departing from the spirit and scope of the invention as defined by the appended claims. Moreover, the scope of the present application is not intended to be limited to the particular embodiments of the invention described in the specification. As one of ordinary skill in the art will readily appreciate from the disclosure of the present invention, the compositions, processes, methods, and steps, presently existing or later to be developed that perform substantially the same function or achieve substantially the same result as the corresponding embodiments described herein may be utilized according to the present invention.

What is claimed is:

1. A tray configured to contain a food product, the tray comprising a bottom surface having a flow restricting element to restrict a flow of the food product in the tray.

2. The tray of claim 1, wherein the flow restricting element comprises an elongated protruding ridge protruding from the bottom surface into a food containing area of the tray.

3. The tray of claim 2, wherein the flow restricting element comprises a plurality of elongated protruding ridges.

4. The tray of claim 3, wherein the ridges comprise between about 10% and about 50% of a surface area of the bottom surface.

5. The tray of claim 2, wherein the bottom surface is generally rectangular, and the ridge is positioned parallel to one side of the bottom surface.

6. The tray of claim 2, wherein the bottom surface is generally rectangular, and the ridge is positioned at an angle relative to one side of the bottom surface.

7. The tray of claim 6, wherein the ridge is positioned at an angle of between about 0 degrees and about 180 degrees relative to one side of the bottom surface.

8. The tray of claim 6, wherein the ridge is positioned at an angle of between about 30 degrees and about 150 degrees relative to one side of the bottom surface.

9. The tray of claim 2, wherein the bottom surface is generally circular, and the ridge is arcuate.

10. The tray of claim 2, wherein the bottom surface has an irregular shape, and the ridge is radial.

11. The tray of claim 1, wherein the flow restricting element comprises a raised pattern on the bottom surface.

12. The tray of claim 11, wherein the raised, textured pattern increases a surface area of the bottom surface by between about 5% and about 30%.

13. The tray of claim 11, wherein the raised pattern comprises a plurality of angular elements.

14. The tray of claim 11, wherein the raised pattern comprises a plurality of diamond-shaped elements.

15. The tray of claim 11, wherein the raised pattern comprises a combination of elements.

16. The tray of claim 1, wherein the tray is made of a material that can withstand baking temperatures.

17. The tray of claim 16, wherein the material is selected from the group consisting of aluminum foil, paperboard, and oven bakeable plastic.

18. A packaged food product capable of being displayed in a non-horizontal configuration while substantially restricting the food product's flow properties within the package, comprising a dough and the tray of claim 1.

19. The packaged food product of claim 18, wherein the dough is a slump-resistant ready-to-bake dough product.

20. The tray of claim 1, further comprising a side wall.
